(19) United States
(12) Patent Application Publication
(10) Pub. No.: US 2026/0202758 A1
(43) Pub. Date: Jul. 16, 2026

(54) METHOD AND APPARATUS WITH SEMICONDUCTOR PROCESS RELIABILITY MEASUREMENT

(71) Applicant: Samsung Electronics Co., Ltd., Suwon-si (KR)

(72) Inventors: Jiwon YEOM, Suwon-si (KR); Jina KIM, Suwon-si (KR); Wonsik YOON, Suwon-si (KR); Young-Seok KIM, Suwon-si (KR); Youngchan KIM, Suwon-si (KR); Junhwi CHOI, Suwon-si (KR); Kyu Young HWANG, Suwon-si (KR)

(73) Assignee: Samsung Electronics Co., Ltd., Suwon-si (KR)

(21) Appl. No.: 19/257,379

(22) Filed: Jul. 1, 2025

(30) Foreign Application Priority Data
Jan. 15, 2025 (KR) 10-2025-0006260

(51) Int. Cl. G03F 7/00

(52) U.S. Cl. CPC G03F 7/706837; G03F 7/7065; G03F 7/70655; G03F 7/706839

(57) ABSTRACT

A processor-implemented method including generating first topology data from raw data through a first model configured to segment a pattern corresponding to a semiconductor fabrication process, generating second topology data in which the first topology data is refined through a second model configured to remove a defect included in the pattern, and calculating reliability data corresponding to the semiconductor fabrication process by matching the first topology data to the second topology data.

### CROSS-REFERENCE TO RELATED APPLICATIONS

This application claims the benefit under 35 USC § 119(a) of Korean Patent Application No. 10-2025-0006260, filed on Jan. 15, 2025, in the Korean Intellectual Property Office, the entire disclosure of which is incorporated herein by reference for all purposes.

### BACKGROUND

### 1. Field

The following description relates to a method and apparatus with semiconductor process reliability measurement based on semiconductor topology.

### 2. Description of Related Art

A semiconductor manufacturing process may include one or more fabrication processes including a patterning process to form a desired circuit pattern on a wafer surface. A highly integrated circuit is formed through the patterning process, and inspection and metrology may be performed on a completed pattern after the patterning process to ensure accuracy of the patterning process. The inspection and metrology process may generally be performed by confirming whether a measurement pattern including shape, size, and arrangement state of the pattern corresponds to a design pattern, and accordingly, it may be determined whether physical characteristics or electrical characteristics required for an operation of the circuit are satisfied.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including generating first topology data from raw data through a first model configured to segment a pattern corresponding to a semiconductor fabrication process, generating second topology data in which the first topology data is refined through a second model configured to remove a defect included in the pattern, and calculating reliability data corresponding to the semiconductor fabrication process by matching the first topology data to the second topology data.

The first model may be configured to receive the raw data, segment the pattern from the raw data, and output the first topology data in a binary matrix format.

The calculating of the reliability data may include determining a difference region by matching the first topology data to the second topology data and calculating a statistical value based on the difference region.

The calculating of the reliability data may include calculating the reliability data by matching the first topology data to process design data, in response to an availability of the process design data corresponding to the semiconductor fabrication process.

The generating of the second topology data may be performed in response to an unavailability of process design data that matches the first topology data.

The first model may include a model trained to generate the first topology data by segmenting a pattern from the raw data, based on a plurality of pieces of process design data corresponding to each of a plurality of processes within the semiconductor fabrication process and the pattern may be based on an input process of the plurality of processes corresponding to an inputting of the raw data.

The second model may be updated based on a loss value of a third model, the third model being trained to classify the second topology data generated by the second model and to process design data corresponding to the second topology data.

The raw data may include one or more of image data measured through a microscope device and topographic data measured through a topographic measurement device.

The microscope device may include one or more of a scanning electron microscope (SEM), a transmission electron microscope (TEM), and an optical microscope and the topography measurement device may include one or more of an atomic force microscope (AFM), the SEM, and a laser scanning microscope.

The first topology data may be generated based on a respective material applied in each of a plurality of processes within the semiconductor fabrication process.

In a general aspect, here is provided a non-transitory, computer-readable storage medium storing instructions that, when executed by a processor, cause the processor to perform generating first topology data from raw data through a first model configured to segment a pattern corresponding to a semiconductor fabrication process, generating second topology data in which the first topology data is refined through a second model configured to remove a defect included in the pattern, and calculating reliability data corresponding to the semiconductor fabrication process by matching the first topology data to the second topology data.

In a general aspect, here is provided an electronic apparatus including a memory, at least one processor connected to the memory and configured to execute a computer-readable program included in the memory, and the computer-readable program causes the at least one processor to perform generating first topology data from raw data through a first model configured to segment a pattern corresponding to a semiconductor fabrication process, generating second topology data in which the first topology data is refined through a second model that is configured to remove a defect included in the pattern, and calculating reliability data corresponding to the semiconductor fabrication process by matching the first topology data to the second topology data.

The first model may be configured to receive the raw data, segment the pattern from the raw data, and output the first topology data in a binary matrix format.

The calculating of the reliability data may include determining a difference region by matching the first topology data to the second topology data and calculating a statistical value based on the difference region.

The calculating of the reliability data may include calculating the reliability data by matching the first topology data to process design data, in response to an availability of the process design data corresponding to the semiconductor fabrication process.

The generating of the second topology data may be performed in response to an unavailability of process design data that matches the first topology data.

The first model may include a model trained to generate the first topology data by segmenting a pattern from the raw data, based on a plurality of pieces of process design data corresponding to each of a plurality of processes within the semiconductor fabrication process and the pattern may be based on an input process of the plurality of processes corresponding to an inputting of the raw data.

The second model may be updated based on a loss value of a third model, the third model being trained to classify the second topology data from the second model and to process design data corresponding to the second topology data.

The raw data may include one or more of image data measured through a microscope device and topographic data measured through a topographic measurement device.

The microscope device may include one or more of a scanning electron microscope (SEM), a transmission electron microscope (TEM), and an optical microscope and the topography measurement device may include one or more of an atomic force microscope (AFM), the SEM, and a laser scanning microscope.

Other features and aspects will be apparent from the following detailed description, the drawings, and the claims.

### BRIEF DESCRIPTION OF THE DRAWINGS

FIG. 1 illustrates an example method with semiconductor process reliability measurement based on semiconductor topology according to one or more embodiments.

FIG. 2 illustrates an example method with semiconductor process reliability measurement based on a semiconductor topology according to one or more embodiments.

FIG. 3A illustrates an example process of generating raw data according to one or more embodiments.

FIG. 3B illustrates an example first model according to one or more embodiments.

FIG. 4A illustrates an example second model according to one or more embodiments.

FIG. 4B illustrates an example training process of a second model according to one or more embodiments.

FIG. 5 illustrates an example process of measuring reliability according to one or more embodiments.

FIG. 6 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

As used in connection with various example embodiments of the disclosure, any use of the terms “module” or “unit” means hardware and/or processing hardware configured to implement processor or computer executable instructions (e.g., as code segment(s), program(s), and/or firmware) to configure such processing hardware to perform corresponding operations, and may interchangeably be used with other terms, for example, “logic,” “logic block,” “part,” or “circuitry”. As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such executable instructions may include components such as program components, object-oriented code or program components, class components, and may include processor task components, processes, functions, attributes, procedures, subroutines, segments of the code or program. Executable instructions may further include programs, drivers, firmware, microcode, circuits, data, database, data structures, tables, arrays, and variables. In another non-limiting example, such executable instructions may be executed by one or more central processing units (CPUs) of an electronic device or secure multimedia card.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

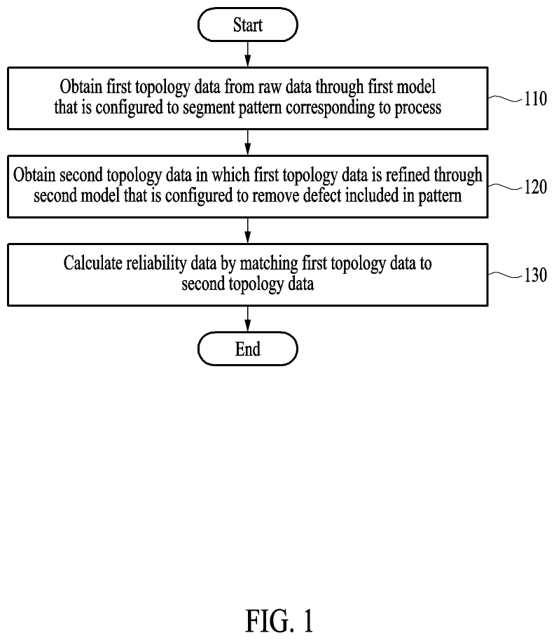

FIG. 1 illustrates an example method with semiconductor process reliability measurement based on semiconductor topology according to one or more embodiments.

Referring to FIG. 1, in a non-limiting example, a method 100 may include operation 110 of obtaining first topology data from raw data through a first model that segments a pattern corresponding to a process.

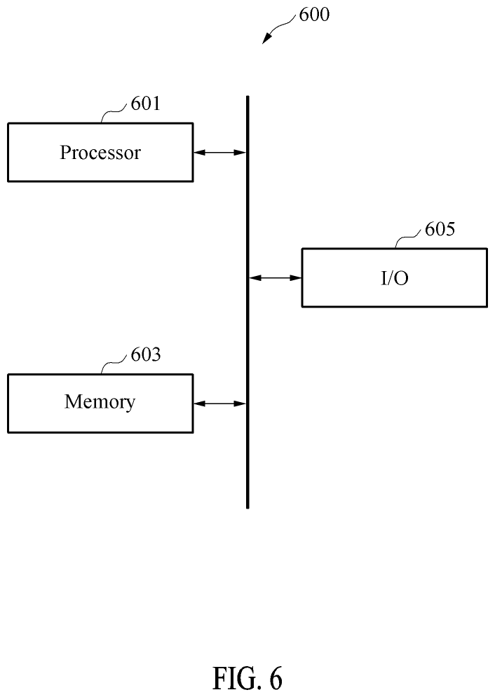

In an example, the method 100 may include measuring reliability of a semiconductor process based on semiconductor topology and may be driven (i.e., performed) by an electronic device including at least one processor (e.g., electronic device 600 of FIG. 6). As described in greater detail below with respect to FIG. 6, the electronic device may be implemented by a single computing module or by a combination of a plurality of computing modules communicating with one another. Depending on the service to which examples are applied, the electronic device may operate in a form of a server, in a form an edge device, or in some cases, in a form in which a server and an edge device may communicate with each other. For example, the electronic device may run a software as a service (SaaS) that provides reliability of a semiconductor process measured based on semiconductor topology.

In an example, the term semiconductor fabrication process may refer to at least one manufacturing or fabrication process among a series of fabrication processes for semiconductor manufacturing. For example, the process may include a process(es) of forming a circuit pattern on a wafer to manufacture a semiconductor, from among a series of manufacturing processes of manufacturing the semiconductor. The circuit pattern may include shapes that represent an arrangement structure of transistors, logic circuits, memory cells, and/or wiring. Different patterns may be generated depending on a semiconductor process.

In an example, the raw data may include data obtained through inspection and/or metrology processes performed in response to output of each process. The raw data may include image data measured through a microscope or data in which topographic data measured through the microscope is imaged. For example, the microscope may include an electron microscope, an optical microscope, a scanning electron microscope (SEM), an atomic force microscope (AFM), a transmission electron microscope (TEM), and the like. In an example, the image data may include data that expresses two-dimensional image information of a surface obtained through the microscope in pixel units. The topographic data may be data that represents a displacement of a surface as coordinates in an N-dimensional (wherein N is an integer greater than or equal to 1) coordinate space and may include data that quantitatively expresses a shape of the surface. For example, the raw data may include the image data of process output measured through a microscope device (e.g., an SEM, TEM, or optical microscope) or may include the topographic data of process output measured through a topographic measurement device (e.g., an AFM, an SEM, or laser scanning microscopy).

In an example, topology data may include data expressing structural characteristics of the pattern. The structural characteristics of the pattern may include unique properties related to a physical structure such as shape, arrangement, appearance, and size of the pattern. The first topology data may include data that expresses structural characteristics of a pattern segmented from the raw data (a segmentation pattern) in a binary matrix format. For example, in a binary matrix for expressing the topology data, a portion where structures such as transistors, logic circuits, memory cells, and/or wiring included in the pattern are physically arranged on a wafer may be configured with a value of 1, and a portion where the structures are not arranged may be configured with a value of 0. The first topology data may be data generated based on the raw data that has not eliminated defects and may represent structural characteristics of an incomplete pattern with defects. In an example, the first topology data may be obtained differently depending on a material applied in each of a plurality of processes of manufacturing a semiconductor. In a semiconductor manufacturing process, the material applied may vary depending on each process. For example, in an etching process, an oxide film (silicon dioxide (SiO₂)) may be applied, and in a deposition process, tungsten (W) or copper (Cu) may be applied. Accordingly, the pattern of the raw data extracted for each process may vary, and the first topology data may also vary. In the first topology data, the portion where the structures such as transistors, logic circuits, memory cells, and/or wiring included in the pattern are physically arranged on the wafer may be configured with a predetermined value corresponding to the material.

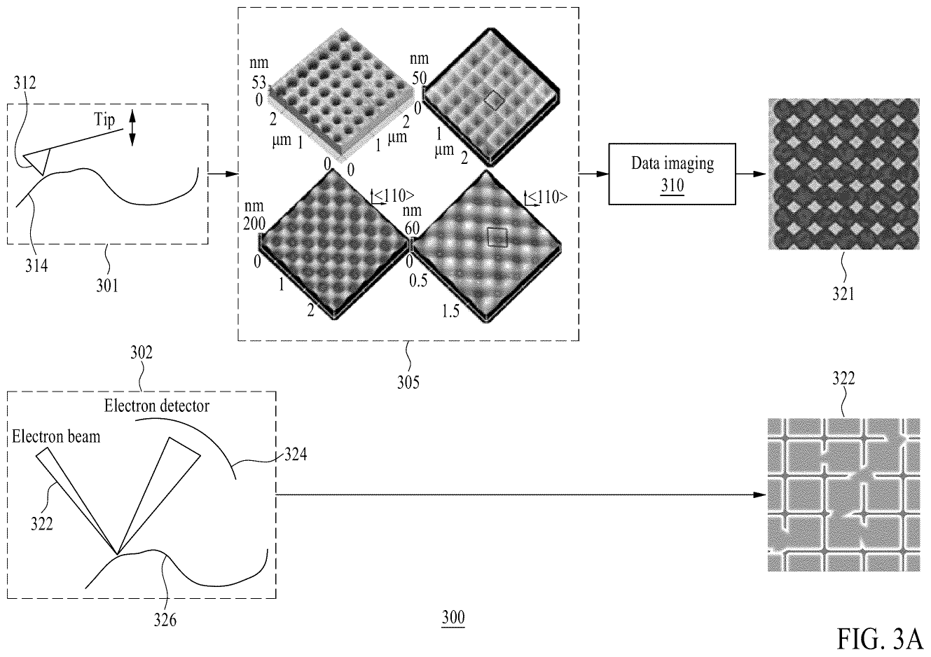

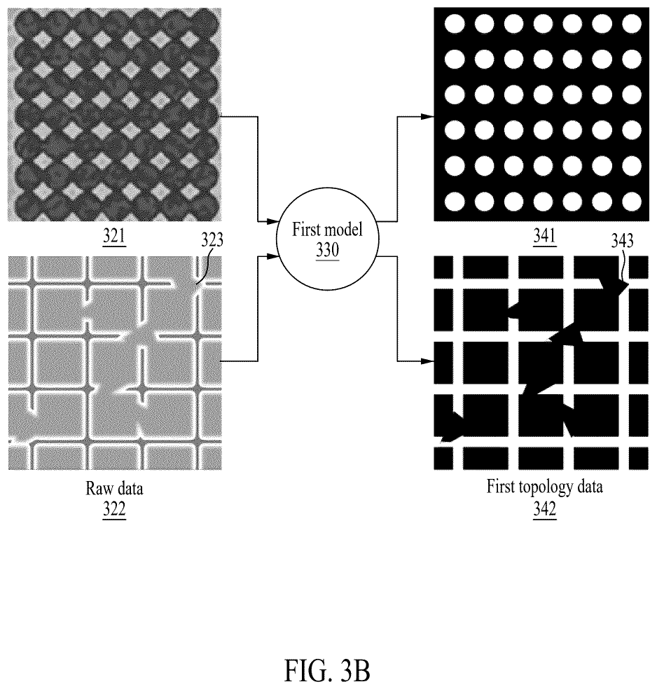

In an example, the first model may segment the pattern corresponding to the process in which reliability is to be measured. The first model may generate and output the first topology data by segmenting the pattern included in the input raw data. The first model according to an example is described in greater detail below with reference to FIGS. 3A and 3B.

In an example, the method 100 may include operation 120 of obtaining second topology data in which the first topology data is refined through a second model that removes a defect included in the pattern.

The defect included in the pattern may include a structure on the wafer that is misaligned or incompletely formed from a desired location due to an error that has occurred during the process. For example, the defect may include a misalignment of relative arrangement between each structure included in the pattern or a partial damage or deformation of a shape of each structure. The second topology data may be data generated by removing the defect from the first topology data including the structural characteristics of an incomplete pattern having the defect. For example, the second topology data may include data having the structural characteristics of a complete pattern.

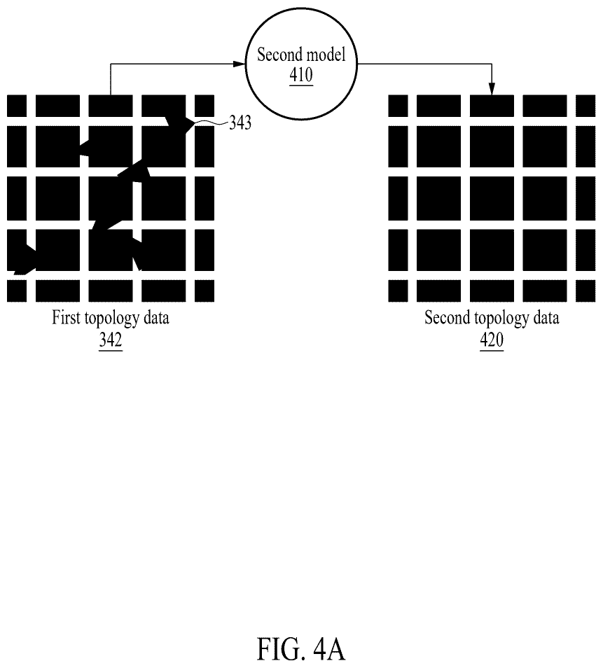

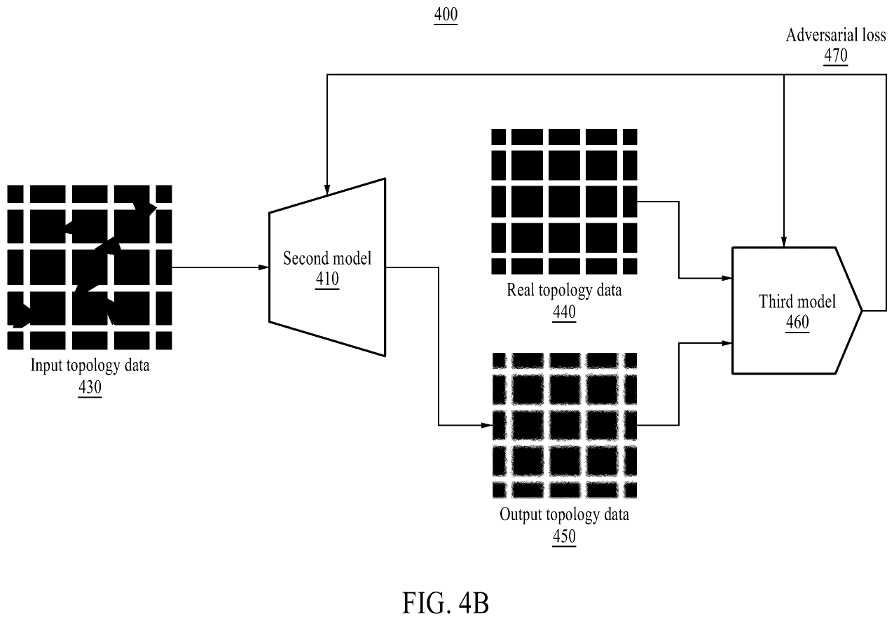

In an example, the second model may remove the defect included in the pattern segmented by the first model in operation 110. The second model may receive the first topology data as input, may remove the defect in the pattern that occurs in the first topology data, and may output the second topology data. The second model may be a generative model that includes trainable parameters. The second model may reduce the possibility of errors occurring based on a physical environment in removing the defect of the pattern by using a trainable model. For example, in removing defects in a lithography process, pattern distortion that may occur due to diffraction may be prevented. The second model is described in greater detail below with reference to FIGS. 4A and 4B.

In an example, operation 120 may be performed even if process design data corresponding to the first topology data does not exist (i.e., is not present or available). The process design data may be data that defines a circuit shape and an arrangement that may be required to achieve an operating purpose of a semiconductor and may include target pattern data. For example, after the process based on an existing process design data is completed, when a new process is added or at least a portion of the existing process is omitted due to a modification of the process, the first topology data obtained according to the modified process may not include corresponding process design data. That is, when the corresponding process design data does not exist within the first topology data, the electronic device may perform operation 120 of obtaining the second topology data in which the first topology data is refined through the second model. Accordingly, the electronic device (e.g., electronic device 600) may perform reliability evaluation even in the absence of original or reference images, thereby efficiently managing pattern quality and contributing to the manufacture of highly reliable semiconductor devices.

In an example, the method 100 may include operation 130 of calculating reliability data by matching the first topology data to the second topology data. Since the second topology data may be generated in a method of removing the defect included in the first topology data, the first topology data and the second topology data may be aligned with each other. The method 100 may, in operation 130, calculate the reliability of the process by comparing a difference between the first topology data and the second topology data. For example, the method 100 may, in operation 130, calculate higher reliability of the process as the difference between the first topology data and the second topology data is smaller. Alternatively, in another example, when the corresponding process design data exists, the electronic device (e.g., electronic device 600) may calculate the reliability data by matching the first topology data to the process design data.

In an example, when matching is performed between the first topology data and the second topology data, the electronic device may obtain a difference region through the matching and may calculate a statistical value based on the difference region. In an example, the matching between the first topology data and the second topology data may be performed based on a correspondence between the two data with respect to location and shape. The electronic device may obtain the difference region based on this matching. For example, when the matching is performed based on a location between the two data, and when the first topology data is used as reference data, the second topology data may be aligned to a same reference coordinate system, and then a comparison may be performed. In addition, when the matching is performed based on a shape observed or taken from between the two data, it may be evaluated whether a first shape of a first pattern included in the first topology data is formed close to a second shape of a second pattern included in the second topology data. For example, when the shape of the pattern is circular, a distance from each point included in the circular pattern to the center may be measured based on a center point of the circular pattern, and it may be confirmed whether a same radius value is maintained at all points within the pattern, and when radius values are different at some points, the corresponding points may be extracted as a difference region.

In an example, the difference region that was obtained by matching may be regarded as a region reflecting the pattern defect due to an error in the process. For example, the statistical value based on the difference region may be obtained based on an area occupied by the difference region. For example, the statistical value may include a ratio of a difference area to an area of entire first topology data.

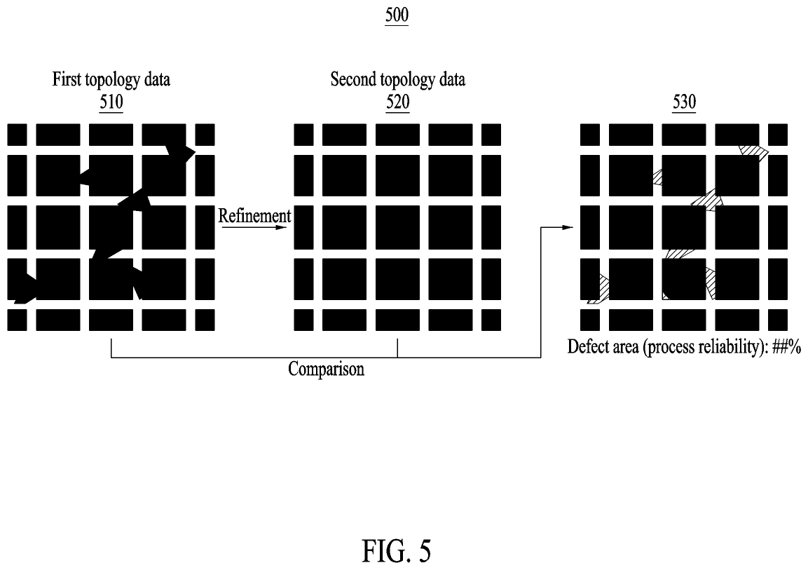

FIG. 5 illustrates an example process of measuring reliability according to one or more embodiments.

Referring to FIG. 5, in a non-limiting example, a method 500 with measuring process reliability based on the difference region is illustrated. First, an electronic device (e.g., electronic device 600) may refine first topology data 510 representing a pattern including a defect to generate second topology data 520 representing a pattern from which the defect is removed. Thereafter, the electronic device may match and compare the first topology data 510 to the second topology data 520 to obtain a comparison result 530 including a difference region between the two data. For example, the difference region may correspond to a hatched portion of the comparison result 530. The difference region may represent a portion where the patterns before and after refinement do not match due to the defect. The electronic device may obtain process reliability data by calculating a statistical value based on this difference region which may include, for example, a ratio of the difference region occupying in the total area.

In an example, the electronic device may calculate a reliability by assigning different weights depending on a location or type of occurrence of the difference region. For example, when the defect occurs in the center of the circular pattern and has a greater impact on the reliability, a higher weight may be applied because that defect occurred closer to the center of the pattern. In addition, the electronic device may calculate a reliability that reflects actual process quality by considering only a difference region exceeding a predetermined area size, excluding a difference region equal to or below the predetermined area size. Here, a degree of pattern deformation may be quantified by reflecting the difference region according to the characteristics of the defect, thereby quantitatively calculating the process reliability.

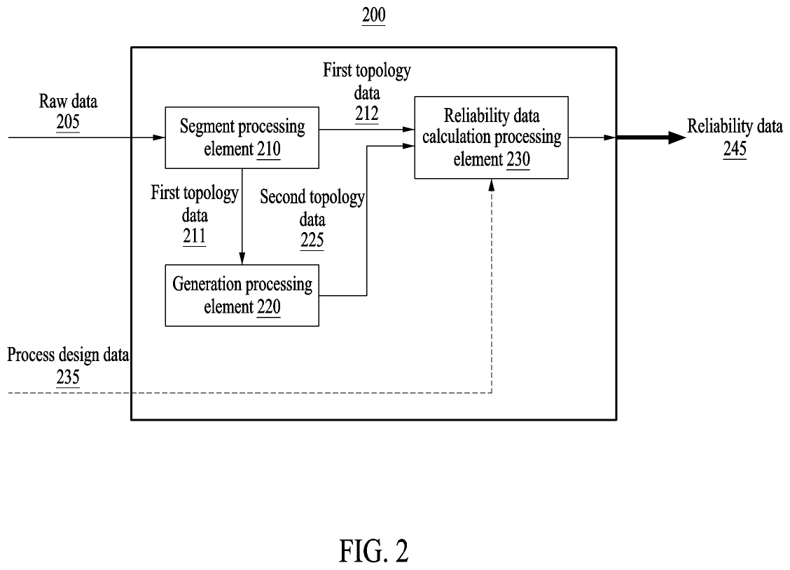

FIG. 2 illustrates an example method with semiconductor process reliability measurement based on a semiconductor topology according to one or more embodiments.

In the following examples, operations of each module and processing element may be performed sequentially but not necessarily. For example, the order of the operations of the processing element may be changed, and at least two of the operations may be performed in parallel. Additionally, for ease of description, each processing element is described separately from the others, but each processing element may be understood as a logically distinct concept. Each of the processing elements may be implemented by being mounted on one or more server devices according to the server design, and the processing element may communicate with one another in an appropriate manner depending on the implemented form. In another example, the processing elements may be formed by or performed by processors within an electronic device (e.g., processor 610 of electronic device 600).

Referring to FIG. 2, in a non-limiting example, an electronic device 200 may include a segment processing element210, a generation processing element220, and a reliability data calculation processing element (hereinafter referred to as a “calculation processing element”) 230. The segment processing element210 may be performed by a first model that segments a pattern. The segment processing element210 may receive raw data 205 as input and may output first topology data 211 and 212. In an example, the segment processing element210 may transmit the output first topology data 211 and 212 to one or more of the generation processing element220 and the calculation processing element230. For example, when process design data 235 corresponding to the first topology data 211 and 212 exists, the segment processing element210 may not transmit the first topology data 211 to the generation processing element220 and may instead only transmit the first topology data 212 to the calculation processing element230.

In an example, the generation processing element220 may be performed by a second model that removes a defect in the pattern. The generation processing element220 may receive the first topology data 211 as input from the segment processing element210 and may output second topology data 225. The generation processing element220 may generate and output the second topology data 225 by removing the defect in the pattern included in the input first topology data 211. The generation processing element220 may transmit the output second topology data 225 to the calculation processing element230. In an example, the generation processing element220 may not generate the second topology data 225 when the process design data 235 exists for a measured process.

In an example, the calculation processing element230 may receive, as an input, the first topology data 212 received from the segment processing element210 and the second topology data 225 received from the generation processing element220 and may output reliability data 245. The calculation processing element230 may generate the reliability data 245 by matching the first topology data 212 to the second topology data 225. In an example, the calculation processing element230 may generate the reliability data 245 by comparing the first topology data 212 to the process design data 235 when the process design data 235 exists in response to the process being measured for reliability.

FIG. 3A illustrates an example process of generating raw data according to one or more embodiments.

Referring to FIG. 3A, in a non-limiting example, a process 300 of generating raw data 321 and 322 that are input to a first model 330 is illustrated. A measurement method 301 may represent a measurement method using an AFM. The measurement method 301 may include measuring a surface shape by moving a tip 312 used in the AFM along a surface of a sample 314. In the measurement method 301, the tip 312 may detect minute height variations on the surface by interacting with each other at a position close to the surface of the sample 314. A movement of a support connected to the tip 312 occurs due to a force (atomic attraction or repulsion) between the tip 312 and the sample 314, and this movement may be detected using a laser (i.e., laser scanning microscopy) to thereby obtain topographic data 305. In an example, the topographic data 305 may include matrix data including each sample location (e.g., x and y-axes coordinate values) and a corresponding height value (e.g., a z-axis coordinate value). An electronic device (e.g., electronic device 600) may obtain the raw data 321 by imaging, in operation 310, the topographic data 305 obtained through the measurement method 301. For example, the electronic device may perform conversion into an image by mapping each pixel to a color that varies in brightness depending on a height value.

In an example, a measurement method 302 may include a measurement performed by a scanning electron microscope (SEM). The measurement method 302 may include generating an image by irradiating an electron beam 322 of an SEM onto a sample surface 326 and collecting, by an electron detector 324, backscattered electrons emitted when the electron beam collides with the sample surface 326. The measurement method 302 may obtain raw data 322 by converting collected electronic signals into a brightness value at each scan point and visualizing the collected electronic signals as a two-dimensional image.

In an example, the measurement method 302 may include detecting and measuring a random location on a wafer to obtain first topology data. In an example, the efficiency of a process of measuring a reliability of measurement process including detecting and measuring at least one random location may be increased because the first topology data may be refined to generate second topology data without using information about the detected and measured location.

FIG. 3A illustrates an example process of generating raw data according to one or more embodiments

Referring to FIG. 3B, in a non-limiting example, an input and output of the first model 330 are illustrated. The first model 330 may receive the raw data 321 and 322 as inputs and may output first topology data 341 and 342. The first model 330 may segment a pattern from the input raw data 321 and 322 and may output the first topology data 341 and 342 in a binary matrix format. The first topology data 341 may represent data obtained from the raw data 321, and the first topology data 342 may represent data obtained from the raw data 322. The first topology data 341 may represent data that segments a pattern formed by a circular structure from the raw data 321 and distinguishes between a portion corresponding to the circular structure and a portion not corresponding to the circular structure. The first topology data 342 may represent data that segments a pattern formed by a rectangular structure from the raw data 322 and distinguishes between a portion corresponding to the rectangular structure and a portion not corresponding to the rectangular structure. The first topology data 342 may represent data obtained from the raw data 322 including defect(s) 323. Accordingly, the first topology data 342 may represent data that distinguishes and expresses not only an intact rectangular structure but also a deformed rectangular structure including defect(s) 343.

In an example, the first model 330 may include a model that performs image segmentation. That is, the first model 330 may be a model including trainable parameters. For example, the trainable first model 330 may include a convolutional neural network (CNN) model. Alternatively, the first model 330 may be a model that is performed based on rules.

In the case of the trainable first model 330, the first model 330 may be trained to generate topology data by segmenting a pattern based on a corresponding process from the input raw data 321 and 322, based on a plurality of process design data corresponding to each of a plurality of processes. Input raw data 321 and 322 that was input to the first model 330 for the purpose of training the first model 330 may include raw data corresponding to each of the plurality of processes performed based on the process design data. The first model 330 may be trained to segment target pattern data from the input raw data and generate the topology data representing structural characteristics of the corresponding pattern data by referring to the process design data of the process corresponding to the input raw data.

FIG. 4A illustrates an example second model according to one or more embodiments.

Referring to FIG. 4A, in a non-limiting example, input and output of a second model 410 are illustrated. The second model 410 may receive the first topology data 342 as input and may output second topology data 420. The second model 410 may generate and output the second topology data 420 by removing the defect(s) 343 of the pattern included in the input first topology data 342. Defect removal performed by the second model 410 may include repositioning a location of a misaligned structure in the first topology data 342 to a target location and refining the first topology data 342 at a pixel level to represent pattern data that changes a damaged or deformed structure in the first topology data 342 into a complete form. For example, the second model 410 may generate the second topology data 420 representing a pattern including only intact rectangular structure(s) by removing the defect(s) 343 expressed by deformed rectangular structure(s) of the first topology data 342.

In an example, the second model 410 may include a generative model that performs image generation. The second model 410 may be a model including trainable parameters. For example, the trainable second model 410 may include a generative model that performs a function of a generator of a general adversarial network (GAN). In an example, the second model 410 may include a CNN-based image generation model that generates an image based on input topology data. The second model 410 may classify characteristics of the input topology data (e.g., classify the characteristics into a normal pattern region or a defective pattern region) using a CNN and may refine the input topology data to represent a pattern that does not include defects based on the classified characteristics.

FIG. 4B illustrates an example training process of a second model according to one or more embodiments.

Referring to FIG. 4B, in a non-limiting example, a training process 400 of the second model 410 is illustrated. The second model 410 may receive, as input, input topology data 430 representing a pattern including a defect. For ease of description, in FIG. 3B, the input topology data 430 is illustrated in the same manner as the first topology data 342, but the input topology data 430 may include any topology data representing a pattern including a defect. The second model 410 may generate output topology data 450 by removing the defect in the pattern included in the input topology data 430.

In an example, a third model 460 may include a classification model that performs a function of a discriminator of the GAN. The third model 460 may be a model including trainable parameters. The third model 460 may receive, as an input, the output topology data 450 and topology data (hereinafter referred to as “real topology data”) 440 obtained based on process design data corresponding to the output topology data 450. The real topology data 440 may include topology data that is converted into a binary matrix form from the process design data or the process design data provided in the form of an image. The third model 460 may be trained to classify the output topology data 450, received as input, as fake data and the real topology data 440 as real data. The third model 460 may output adversarial loss 470 as a result of classification. The trainable parameters included in each of the third model 460 and the second model 410 may be updated based on the adversarial loss 470. The second model 410 may be trained based on the adversarial loss 470 so that the third model 460 classifies the output topology data 450 as real data.

FIG. 6 illustrates an example electronic device according to one or more embodiments.

Referring to FIG. 6, in a non-limiting example, an electronic device 600 may include a processor 601, a memory 603, and a communication module 605. The electronic device 600 according to an example may include an apparatus for measuring reliability of a semiconductor process based on the semiconductor topology described above with reference to FIGS. 1 to 5.

The processor 601 may perform at least one of the operations described above with reference to FIGS. 1 to 5. For example, the processor 601 may perform at least one of obtaining first topology data from raw data through a first model that is configured to segment a pattern corresponding to the process, obtaining second topology data in which the first topology data is refined through a second model that is configured to remove a defect included in the pattern, and calculating reliability data corresponding to the process by matching the first topology data to the second topology data.

The memory may include computer-readable instructions. The processor 601 may be configured to execute computer-readable instructions, such as those stored in the memory 603, and through execution of the computer-readable instructions, the processor 601 is configured to perform one or more, or any combination, of the operations and/or methods described herein. The memory 603 may be a volatile or nonvolatile memory and may store data related to the method of measuring reliability of a semiconductor process described above with reference to FIGS. 1 to 5.

The processor 601 may be configured to execute programs or applications to configure the processor 601 to control the electronic apparatus 600 to perform one or more or all operations and/or methods involving the resolution of a deadlock state and resuming a task, and may include any one or a combination of two or more of, for example, a central processing unit (CPU), a graphic processing unit (GPU), a neural processing unit (NPU) and tensor processing units (TPUs), but is not limited to the above-described examples. For example, the memory 603 may store data generated during the process of performing the method of measuring reliability of a semiconductor process or data required to perform the method of measuring reliability of a semiconductor process. For example, the memory 603 may store raw data, first topology data, second topology data, reliability data, and process design data.

In an example, the communication interface 605 may provide a function for the electronic device 600 to communicate with another electronic device or another server through a network. In other words, the electronic device 600 may be connected to an external device (e.g., a terminal of a user, a server, or a network) through the communication interface 605 and exchange data with the external device.

In an example, the memory 603 may not be a component of the electronic device 600 and may be included in an external device accessible by the apparatus 600. In this case, the electronic device 600 may receive data stored in the memory 603 included in the external device and transmit data to be stored in the memory 603 through the communication interface 605.

In an example, the memory 603 may store a program implementing the method of measuring reliability of a semiconductor process described above with reference to FIGS. 1 to 5.

The electronic device 600 according to an example may further include other components not shown in the drawings. For example, the apparatus 600 may further include an input/output interface including an input device and an output device as the means of interfacing with the communication interface 605. In addition, for example, the apparatus 600 may further include other components, such as a transceiver, various sensors, or a database.

The neural networks, electronic devices, processors, memories, processing elements, electronic device 200, segment processing element 210, generation processing element 220, calculation processing element 230, first model 330, second model 410, electronic device 600, process 601, memory 603, and communication interface 605 described herein and disclosed herein described with respect to FIGS. 1-6 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
generating first topology data from raw data through a first model configured to segment a pattern corresponding to a semiconductor fabrication process;
generating second topology data in which the first topology data is refined through a second model configured to remove a defect included in the pattern; and
calculating reliability data corresponding to the semiconductor fabrication process by matching the first topology data to the second topology data.

2. The method of claim 1, wherein the first model is configured to receive the raw data, segment the pattern from the raw data, and output the first topology data in a binary matrix format.

3. The method of claim 1, wherein the calculating of the reliability data comprises:
determining a difference region by matching the first topology data to the second topology data; and
calculating a statistical value based on the difference region.

4. The method of claim 1, wherein the calculating of the reliability data comprises:
calculating the reliability data by matching the first topology data to process design data, in response to an availability of the process design data corresponding to the semiconductor fabrication process.

5. The method of claim 1, wherein the generating of the second topology data is performed in response to an unavailability of process design data that matches the first topology data.

6. The method of claim 1, wherein the first model comprises a model trained to generate the first topology data by segmenting a pattern from the raw data, based on a plurality of pieces of process design data corresponding to each of a plurality of processes within the semiconductor fabrication process, and
wherein the pattern is based on an input process of the plurality of processes corresponding to an inputting of the raw data.

7. The method of claim 1, wherein the second model is updated based on a loss value of a third model, the third model being trained to classify the second topology data generated by the second model and to process design data corresponding to the second topology data.

8. The method of claim 1, wherein the raw data comprises one or more of image data measured through a microscope device and topographic data measured through a topographic measurement device.

9. The method of claim 8, wherein the microscope device comprises one or more of a scanning electron microscope (SEM), a transmission electron microscope (TEM), and an optical microscope, and
wherein the topography measurement device comprises one or more of an atomic force microscope (AFM), the SEM, and a laser scanning microscope.

10. The method of claim 1, wherein the first topology data is generated based on a respective material applied in each of a plurality of processes within the semiconductor fabrication process.

11. A non-transitory, computer-readable storage medium storing instructions that, when executed by a processor, cause the processor to perform:
generating first topology data from raw data through a first model configured to segment a pattern corresponding to a semiconductor fabrication process;
generating second topology data in which the first topology data is refined through a second model configured to remove a defect included in the pattern; and
calculating reliability data corresponding to the semiconductor fabrication process by matching the first topology data to the second topology data.

12. An electronic apparatus, the apparatus comprising:
a memory; and
at least one processor connected to the memory and configured to execute a computer-readable program included in the memory,
wherein the computer-readable program causes the at least one processor to perform:
generating first topology data from raw data through a first model configured to segment a pattern corresponding to a semiconductor fabrication process;
generating second topology data in which the first topology data is refined through a second model that is configured to remove a defect included in the pattern; and
calculating reliability data corresponding to the semiconductor fabrication process by matching the first topology data to the second topology data.

13. The apparatus of claim 12, wherein the first model is configured to receive the raw data, segment the pattern from the raw data, and output the first topology data in a binary matrix format.

14. The apparatus of claim 12, wherein the calculating of the reliability data comprises:
determining a difference region by matching the first topology data to the second topology data; and
calculating a statistical value based on the difference region.

15. The apparatus of claim 12, wherein the calculating of the reliability data comprises:
calculating the reliability data by matching the first topology data to process design data, in response to an availability of the process design data corresponding to the semiconductor fabrication process.

16. The apparatus of claim 12, wherein the generating of the second topology data is performed in response to an unavailability of process design data that matches the first topology data.

17. The apparatus of claim 12, wherein the first model comprises a model trained to generate the first topology data by segmenting a pattern from the raw data, based on a plurality of pieces of process design data corresponding to each of a plurality of processes within the semiconductor fabrication process, and
wherein the pattern is based on an input process of the plurality of processes corresponding to an inputting of the raw data.

18. The apparatus of claim 12, wherein the second model is updated based on a loss value of a third model, the third model being trained to classify the second topology data from the second model and to process design data corresponding to the second topology data.

19. The apparatus of claim 12, wherein the raw data comprises one or more of image data measured through a microscope device and topographic data measured through a topographic measurement device.

20. The apparatus of claim 19, wherein the microscope device comprises one or more of a scanning electron microscope (SEM), a transmission electron microscope (TEM), and an optical microscope, and
wherein the topography measurement device comprises one or more of an atomic force microscope (AFM), the SEM, and a laser scanning microscope.
